(19) United States
(12) Patent Application Publication
(10) Pub. No.: US 2022/0051610 A1
(43) Pub. Date: Feb. 17, 2022

(54) SYSTEM AND METHOD FOR LED DRIVERS PROVIDING TWO-DIMENSIONAL DUTY-CYCLE MODULATION FOR LEDS

(71) Applicant: Unilumin Group Co., Ltd., Shenzhen (CN)

(72) Inventor: SHAHNAD NADERSHAHI, Portland, OR (US)

(73) Assignee: Unilumin Group Co., Ltd.

(21) Appl. No.: 17/240,740

(22) Filed: Apr. 26, 2021

Related U.S. Application Data
(60) Provisional application No. 63/065,393, filed on Aug. 13, 2020.

(51) Int. Cl. G09G 3/32

(52) U.S. Cl. CPC G09G 3/32; G09G 2310/08; G09G 2330/02; G09G 2320/0686; G09G 2300/08; G09G 2320/0242; G09G 2320/0693; G09G 2330/08

(57) ABSTRACT

The present disclosure provides LED drivers and methods for driving LED matrixes in response to display signals. According to one exemplary embodiment, an LED driver is provided. The LED driver includes a two-dimensional pulse profile engine that receives display signals and timing signals, and produces a pulse profile defining signal amplitudes at various times during a driving pulse to produce a desired LED output that accounts for artifacts of the LED matrix and other driver circuitry. The LED driver further includes current forming circuitry and driver circuitry. The current forming circuitry can be configured to form a driving pulse to reflect the pulse profile. The driver circuitry can be coupled to the two-dimensional pulse profile engine and the current forming circuitry for forming a current pulse to one or more LEDs in the matrix.

### CROSS-REFERENCE TO RELATED APPLICATIONS

This application claims priority to and the benefit of U.S. Provisional Application No. 63/065,393, filed on Aug. 13, 2020, the entirety of which is incorporated herein by reference.

### TECHNICAL FIELD

The present disclosure relates generally to techniques for driving LEDs, and more specifically, to driving LED display panels with signals that compensate for parasitic effects of the LEDs.

### BACKGROUND

RGB (red/green/blue) LED panels contain a matrix of RGB LEDs that typically have either a common-anode or common-cathode configuration. An RGB LED has tiny red, green and blue LEDs and a common terminal. If the LED has a common positive terminal, it is common-anode LED, and if it has a common negative terminal, it is common-cathode LED. Drivers for common-anode LEDs are often simpler to design, but common-cathode LEDs generally consume less power.

Parasitic effects and other LED matrix anomalies can degrade current signals driving LEDs in an LED matrix or panel. Various factors can affect the current signals driving and controlling LED displays, such as physical properties of the LED panels (especially large panels), effects of voltage, and temperature variations. Some techniques seek to address chip-to-chip-to-chip and device-to-device output current variations. However, existing techniques have many disadvantages, for example, existing techniques do not address performance of LED drivers under excessive network load. Therefore, there is a need for improved LED drivers and techniques to properly control current signals driving LEDs.

### SUMMARY

In view of the shortcomings of existing techniques, the present disclosure provides LED drivers and methods for driving LED matrixes in response to display signals. According to one exemplary embodiment, an LED driver is provided. The LED driver includes a two-dimensional pulse profile engine that receives display signals and timing signals, and produces a pulse profile defining signal amplitudes at various times during a driving pulse to produce a desired LED output that accounts for artifacts of the LED matrix and other driver circuitry. The LED driver further includes current forming circuitry and driver circuitry. The current forming circuitry can be configured to form a driving pulse to reflect the pulse profile. The driver circuitry can be coupled to the two-dimensional pulse profile engine and the current forming circuitry for forming a current pulse to one or more LEDs in the matrix.

### BRIEF DESCRIPTION OF THE DRAWINGS

The accompanying drawings are not necessarily to scale or exhaustive. Instead, the emphasis is generally placed upon illustrating the principles of the embodiments described herein. These drawings, which are incorporated in and constitute a part of this specification, illustrate several embodiments consistent with the disclosure and, together with the detailed description, explain the principles of the disclosure. In the drawings:

FIG. 1 is a circuit diagram of an exemplary LED matrix in a common-cathode configuration, according to some embodiments of the present disclosure.

FIGS. 2A-2D are a set of timing diagram of exemplary ideal and actual driving signals, according to some embodiments of the present disclosure.

FIG. 3 is a graph showing exemplary variations in the slopes of the rise and decay times for the different LED colors, according to some embodiments of the present disclosure.

FIG. 4 is a block diagram of an exemplary system for driving a sixteen-channel LED matrix using the two-dimensional duty-cycle modulation (2D-DCM) technique, according to some embodiments of the present disclosure.

FIGS. 5A-5D are an exemplary set of timing diagrams for driving signals from the system in FIG. 4, according to some embodiments of the present disclosure.

FIG. 6 is an exemplary set of timing diagrams showing how the 2D-DCM techniques can make the rise times for driving signals for different color LEDs have the same slope, according to some embodiments of the present disclosure.

FIG. 7 is a timing diagram of an exemplary ideal pulse and a possible driving pulse to produce a similar shape, according to some embodiments of the present disclosure.

FIG. 8 is a block diagram of an exemplary compensation circuit, according to some embodiments of the present disclosure.

FIG. 9 is a block diagram of another exemplary compensation circuit, according to some embodiments of the present disclosure.

FIG. 10 is a diagram of an exemplary boost level engine, according to some embodiments of the present disclosure.

FIG. 11 is a flow chart of an exemplary calibration process, according to some embodiments of the present disclosure.

### DETAILED DESCRIPTION

Reference will now be made in detail to exemplary embodiments discussed regarding the accompanying drawings. In some instances, the same reference numbers will be used throughout the drawings and the following description to refer to the same or like parts. The disclosed materials, methods, and examples are illustrative only and are not intended to be limiting.

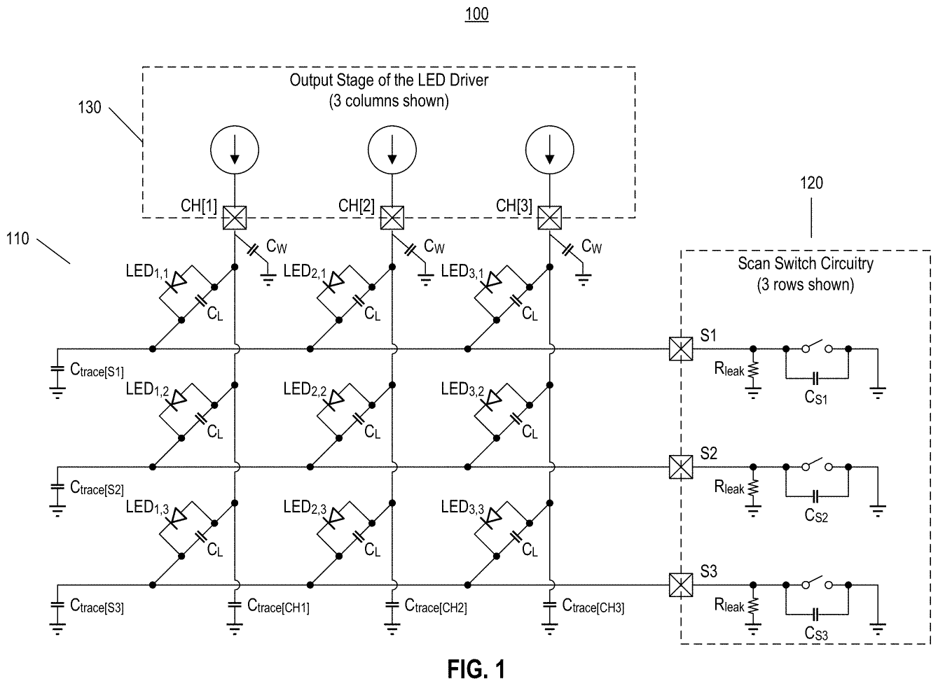

FIG. 1 is a circuit diagram of an exemplary LED matrix 100 in a common-cathode configuration, according to some embodiments of the present disclosure. This example shows LED matrix 100 in a common-cathode configuration with in (in this example m=3) channels (in this example columns) each with n (in this example n=3) LEDs 110. LEDs 110 are denoted LED_{i,j}, where “i” is the channel number and “j” is the row number for an LED in the matrix. In some embodiments, scan switches 120 can use negative-channel metal-oxide semiconductor (NMOS) devices.

LED drivers 130 drive several LEDs at the same time and contain metal-oxide semiconductor (MOS) transistors that turn on and off in a time-multiplexed manner to activate only one output driver per scan line and one LED per time slot.

For example, to illuminate an LED in a common-cathode configuration topology, a current flows from LED driver 130 for the channel with that LED, through LED 110, and through an NMOS scan switch 120 for the activated scan line. The current from LED driver 130 caused the intended LED to have a brightness defined by a grey-scale vector. The grey-scale vector indicates how a device driving an LED panel controls the LEDs' bit-depth and resolution.

To deliver the proper amount of current, some driving circuitry uses pulse-width modulation (PWM) techniques that vary the duration of fixed-amplitude driving pulses to deliver different amounts of current. PWM circuits use a digital signal to control the pulse width. The number of bits in a grey-scale vector defines the resolution of a PWM pulse. For example, a 16-bit grey-scale vector allows up to 64K (2¹⁶) grey-scale values.

Physical properties of LED panels, especially large panels, can make controlling the display difficult. Intrinsic or stray capacitances, which FIG. 1 shows as C_{L}, are a distributed source of noise. In addition, intrinsic capacitances and inductances on the printed circuit boards (PCBs) also cause coupling and crosstalk, which can degrade the driving signals.

One performance characteristic of an LED display is the high dynamic range, which indicates the range of color and contrast in digital image. To achieve high dynamic range, an LED display must render very low brightness values as well as large brightness values. Achieving very high brightness has its own challenges. Properly rendering very low brightness values also creates a challenge in designing systems to drive large LED panels.

Stray capacitances, the intrinsic resistive load of the traces, and the input and output impedances of the components in the network make precisely driving a large LED panel difficult due to rise time effects and long decay periods that affect proper synchronization of time-critical signals.

Large LED panels with narrow-pitch LED displays suffer from various additional effects, such as RGB imbalance, color smearing and smudges, and color banding. These effects can make it difficult to achieve low brightness resolution with fidelity.

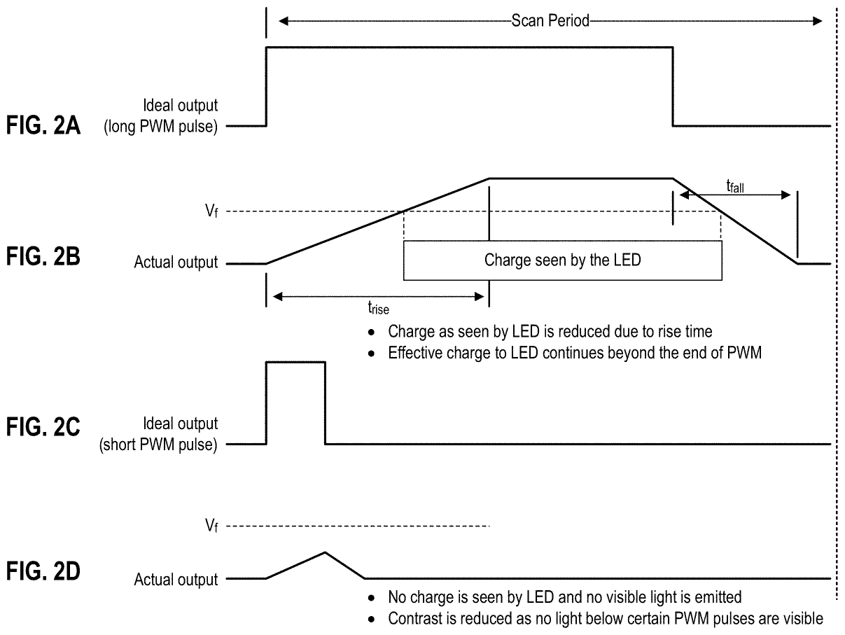

FIGS. 2A-2D is a set of timing diagram of exemplary ideal and actual driving signals, according to some embodiments of the present disclosure. This example illustrates the effects the factors mentioned above can have on critical timing signals. As shown in the figures, FIG. 2A shows a signal representing the ideal current for an LED with a long pulse for high brightness. FIG. 2B shows a signal representing the actual signal the LED sees (the real signal has a logarithmic rising and falling edges) due to parasitic effects. The sharp pulse now has a long rise time when the LED turns on and a long fall time when the LED turns off. The charge the LED sees is offset from and shorter than the desired signal A, causing a signal with lower brightness that is not synchronized with the other signals.

The situation can be worse for short pulses, which are for low brightness levels. FIG. 2C shows a signal representing the ideal charge for a short pulse, and FIG. 2D shows the actual signal the LED sees. In that case, the LED never turns on because the charge never reaches a sufficient level. One effect of this is reduced contrast because the LED panel cannot display low-brightness signals.

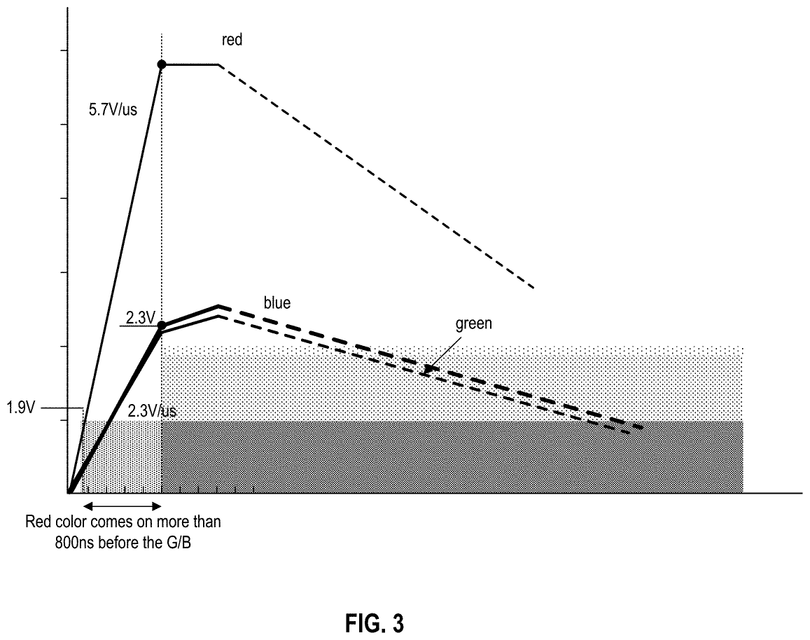

In addition, the variations in the slope of the rise and decay times for the different LED colors can cause color smearing. FIG. 3A and FIG. 3B are diagrams showing exemplary variations in the slopes of the rise and decay times for the different LED colors, according to some embodiments of the present disclosure. FIG. 3 shows that if the same pulses drive the red, green, and blue LEDs, the red color comes on more than 800ns before the green and blue colors.

To compensate for the parasitic effects and other LED matrix anomalies degrading current signals driving LEDs in a matrix or panel, the following provides description of exemplary embodiments using two-dimensional duty-cycle modulation (2D-DCM) techniques, and explains how these techniques can drive LEDs to provide a more consistent and precise delivery of current and charge to the LEDs, such as at low brightness levels.

In some embodiments, an LED driver can be used to provide dynamic current compensation that provides fine adjustments to the driving current to overcome the degradation LED panel circuitry imparts to the driving signal, such as to its rise time.

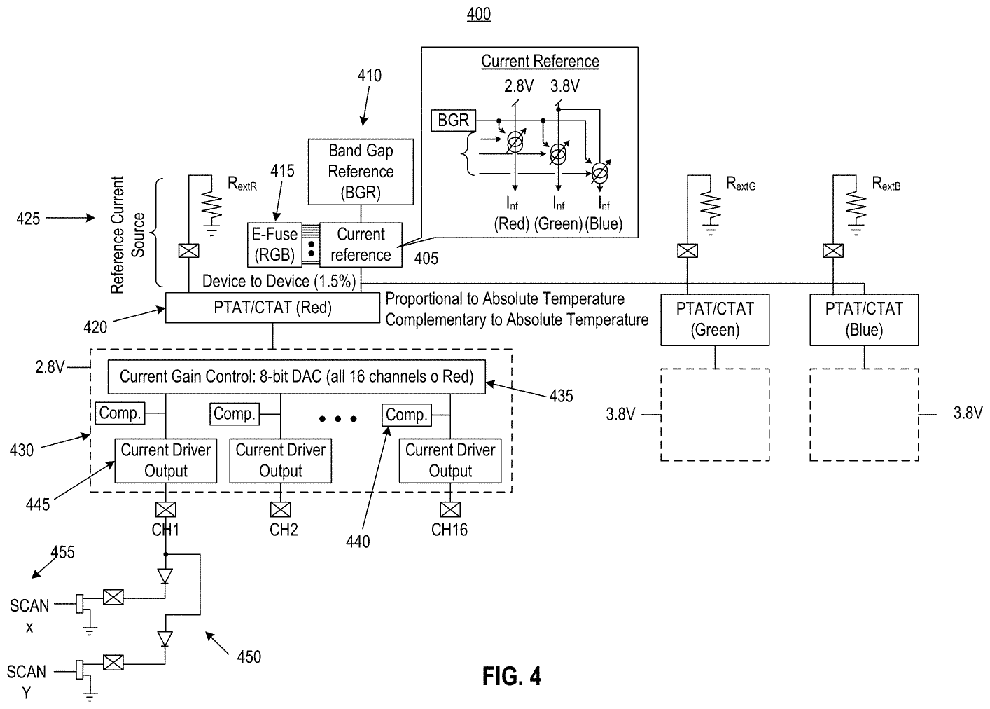

FIG. 4 shows a block diagram of an exemplary system 400 for driving a sixteen-channel LED matrix using the 2D-DCM technique, according to some embodiments of the present disclosure. As shown in FIG. 4, system 400 includes several constant-current references 405 powered by a band-gap reference (BGR) source 410. A manufacturer can set electronic fuses 415 to equalize the current references for different devices. PTAT/CTAT control 420, which connects to reference current source 425, provides temperature compensation that is proportional or complementary to absolute temperature. There is a different PTAT/CTAT control 420 for each color.

Each color has a driving circuit 430 that includes several components. One is an eight-bit DAC (digital-analog converter) 435 that controls the current gain for all the channels for the corresponding color. Compensation circuits 440 (one per channel) provide the 2D-DCM compensation. Current drivers 445 send the driving current to the LEDs for the corresponding color. The LED matrix (shown in part by LEDs 450) connects to current drivers 445 and scan switches 455.

Driving circuits 430 for all the colors can be similar. It is also appreciated that blue and green LEDs operate with a higher voltage than the red LEDs.

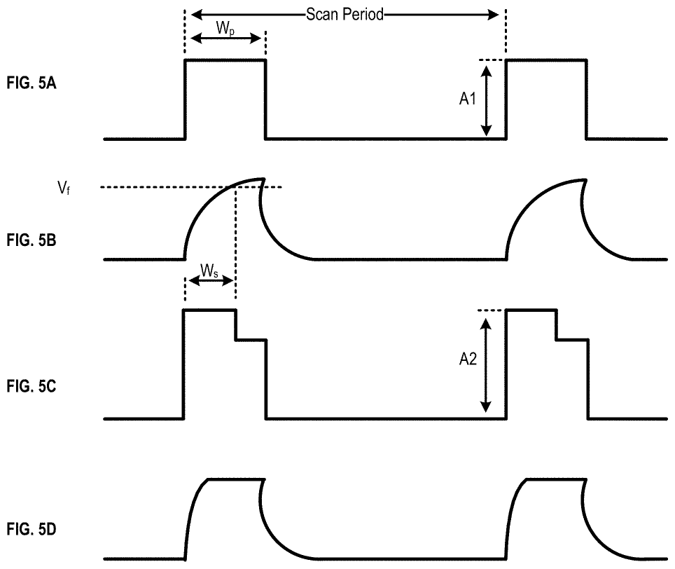

FIGS. 5A-5D are an exemplary set of timing diagrams for driving signals from the system in FIG. 4 using the 2D-DCM technique, according to some embodiments of the present disclosure. FIG. 5A represents an ideal current signal of magnitude Al for duration Wₚ. FIG. 5B represents the current signal the LED would see without the 2D-DCM or other compensation. FIG. 5C represents a current signal created using the 2D-DCM technique, which boosts the current to A2 for a duration Wₛ, and then returns to Al for the remainder of Wₚ. Wₛ in this example indicates the amount of time it takes the signal in FIG. 5B to reach V_{f}, the threshold voltage, to turn on the corresponding LED. FIG. 5D represents the current signal the LED sees from the signal in FIG. 5C. The current signal in FIG. 5D is a much better approximation of the ideal current signal in FIG. 5A than is the signal in FIG. 5B.

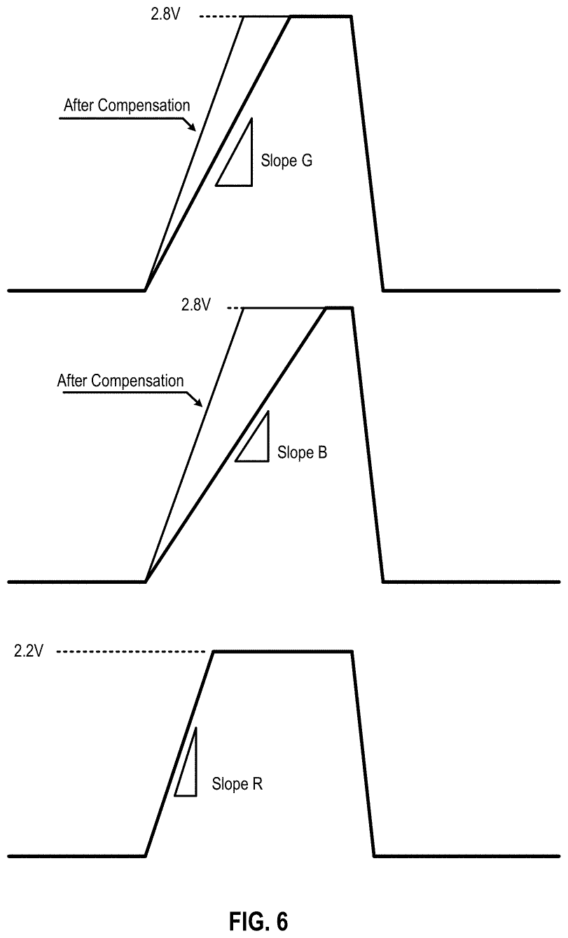

By correcting the rise times of the red, green, and blue driving signals, the 2D-DCM techniques can improve synchronization between red, green, and blue LEDs. FIG. 6 is an exemplary set of timing diagrams showing how the 2D DCM techniques can make the rise times for driving signals for different color LEDs have the same slope, according to some embodiments of the present disclosure. As shown in FIG. 6, the compensation provided can make the rise times of those signals have the same slope so they can better synchronize with each other. That can produce dynamic adjustment pre-emphasis.

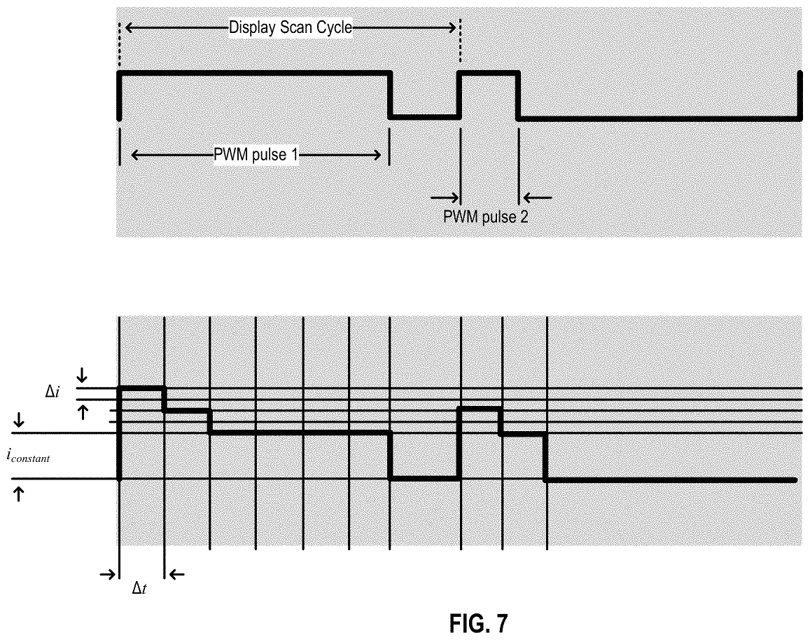

Further, the 2D-DCM technique can also provide dynamic adjustment to the early portions of the signals by adjusting the size and duration of the pulses. FIG. 7 is a timing diagram of an exemplary ideal pulse and a possible driving pulse to produce a similar shape, according to some embodiments of the present disclosure. The example in FIG. 7 shows one way to accomplish dynamic adjustments for a wide pulse (high brightness) and a narrow pulse (low brightness) signal. The driving system can provide a constant base current i_{constant}, representing the lowest value of a signal, and steps of additional current, Δi.

As shown in FIG. 7, the driving current to produce a longer driving signal, PWM pulse 1, is i_{constant}+4Δi for the first grey-scale clock period Δt, then i_{constant}+2Ai for the second grey-scale clock period, then i_{constant} for the next four grey-scale clock periods, before turning off.

The waveform current to produce a shorter driving signal, PWM pulse 2, is i_{constant}+2Δi for the first grey-scale clock period, then i_{constant} for the next grey-scale clock period, before turning off. These are just examples of what is possible using the 2D-DCM technique.

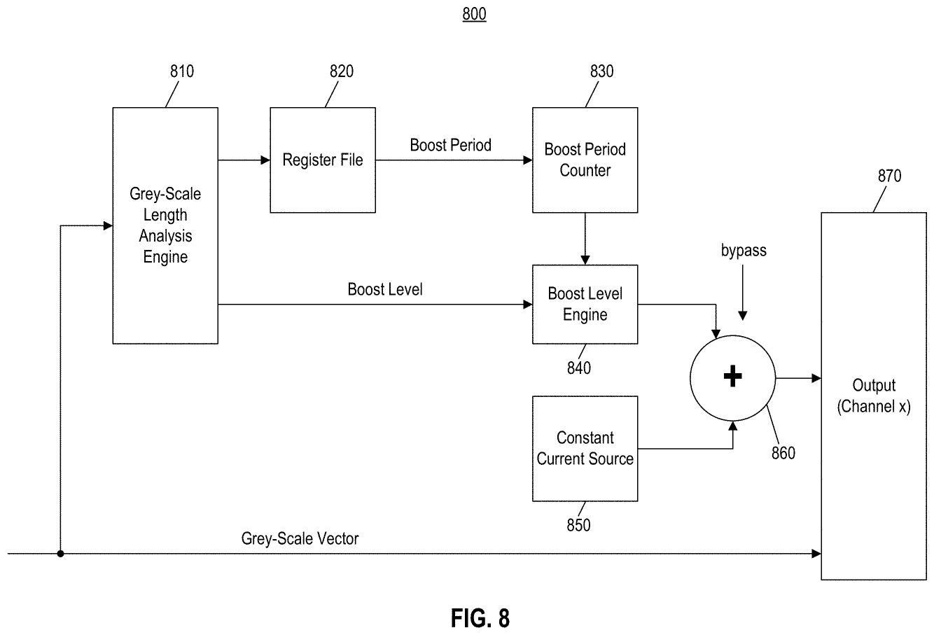

FIG. 8 is a block diagram of an exemplary compensation circuit 800, according to some embodiments of the present disclosure. Compensation circuit 800 that can function as compensation circuit 440 in system 400 that FIG. 4 shows. As shown in FIG. 8, in circuit 800, grey-scale length analysis engine 810 receives a grey-scale vector, analyzes the resolution (which is a digital number that in other systems defines the length of a PWM pulse), and uses that analysis to select a predefined boost scenario from register file 820. That boost scenario defines current boost levels for different periods, which is the profile for the driving signal. For example, if one of those scenarios defined a boost level of 5 for five clock cycles, followed by a boost level of 3 for two clock cycles, and a baseline current for the remaining thirteen clock cycles, grey-scale length analysis engine 810 would instruct register file 820 to generate signals to cause boost period counter 830 to count the clock cycles and apply the needed boost currents through boost level engine 840 during the first seven clock cycles. Constant current source 850 provides a baseline current, which adder 860 combines with the output of boost level engine 840 to form the profile that output 870 uses to drive a channel of the LED matrix. Register file 820 can be any addressable memory, such as a static memory.

Boost period counter 830 can include a digital counter that counts at the grey-scale clock frequency to determine the period of the boost segments. Output 870 switches off the currents according to the timing the grey-scale vector defines, and conditions the current signal to drive the LED channel. Output 870 can also be combined with current driver 445 in FIG. 4.

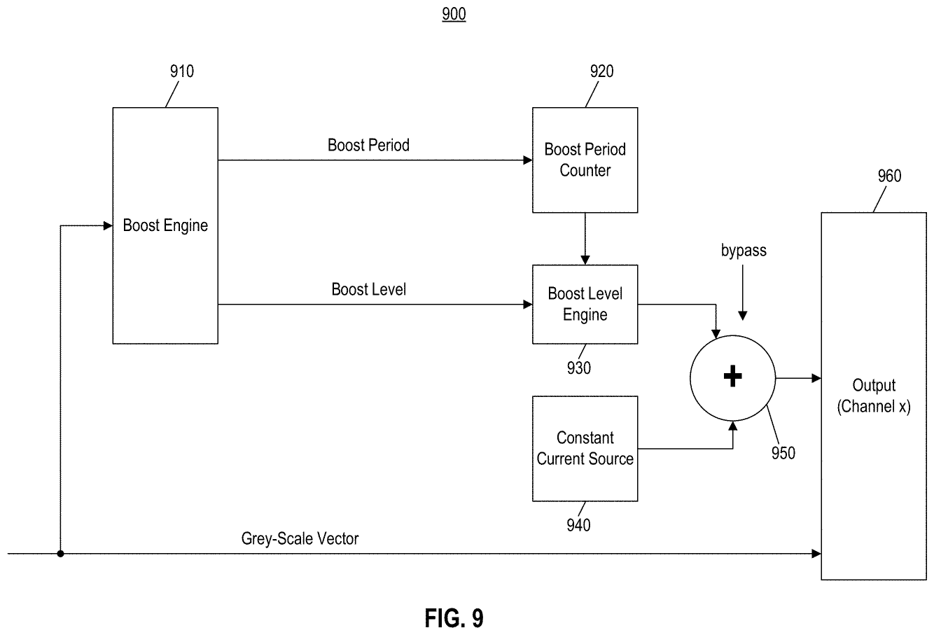

FIG. 9 is a block diagram of another exemplary compensation circuit 900, according to some embodiments of the present disclosure. In this example, compensation circuit 900 can implement the 2D-DCM technique without predefined scenarios. Boost engine 910 receives a grey-scale vector and analyzes it according to an algorithm developed to determine the proper compensation. The analysis determines the level of the boost current for different time periods. Boost engine 910 synchronizes boost period counter 920 and boost level engine 930 to produce the proper current profile based on the compensation it determined. There are no predefined scenarios in FIG. 9, and boost engine 910 controls the level of the boost current. Adder 950 combines the boost current from boost level engine 930 and the baseline current from constant current source 940 to form the profile of the driving current for the corresponding channel, and output 960 outputs the driving current for that channel

Boost period counter 920, constant current source 940, adder 950, and output 960 can operate in a manner like the operation of boost period counter 830, constant current source 850, adder 860, and output 870 in FIG. 8.

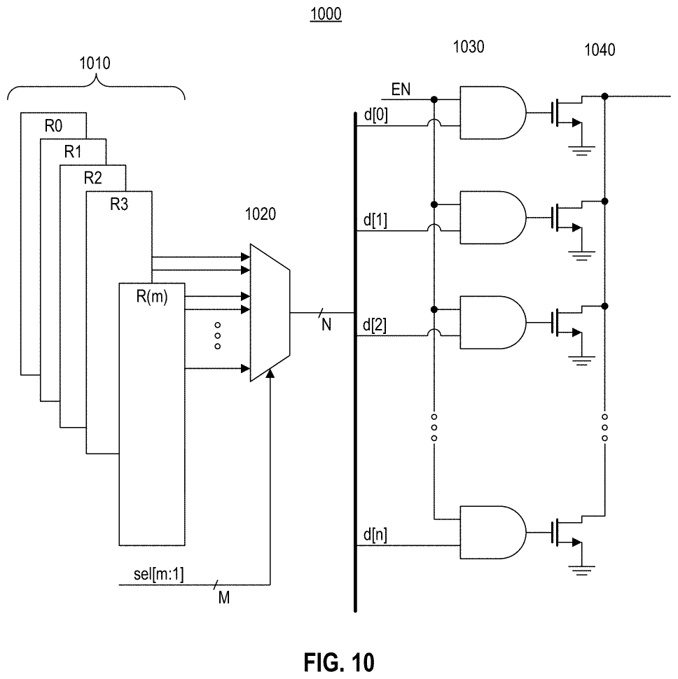

FIG. 10 is a diagram of an exemplary boost level engine 1000, according to some embodiments of the present disclosure. In some embodiments, boost level engine 1000 can serve as boost level engine 840 in FIG. 8. Similar processing can also be incorporated into boost engine 910 in FIG. 9. As shown in FIG. 10, registers 1010 contain data vectors for each boost level. Multiplexer 1020 uses the boost level vector from grey-scale length analysis engine 810 in FIG. 8 (or boost engine 910 in FIG. 9) to select the appropriate boost level vector, which in turn controls drivers 1030 for current switches 1040. The values d(1) to d(n) can be the bits in the boost level vector.

In some embodiments, the 2D-DCM system selects the boost values and the boost periods for each display panel using a low-level brightness calibration process. That process can involve setting the screen to very low brightness settings in a dark room and using a sensitive camera to capture the brightness from each LED. The boost values for the boost periods are varied until the optimal brightness is captured. At that point, the values are set and can be stored for that manufacturing run of panels.

This calibration preferably takes place before calibrating brightness and chroma to normalize the LED batches to remove variations due to manufacturing tolerances. Normalization removes odd readouts from the collected database of the sense information before averaging. This filters out the noise in the vector processing procedure. For example, after completing calibration, an analysis of the stored data for LED emission can eliminate anomalous readings and the remaining values can be averaged to normalize the data set. The system uses that normalized data set to select the appropriate boost level and boost period scenarios for a manufacturing run of display panels, or for a single panel.

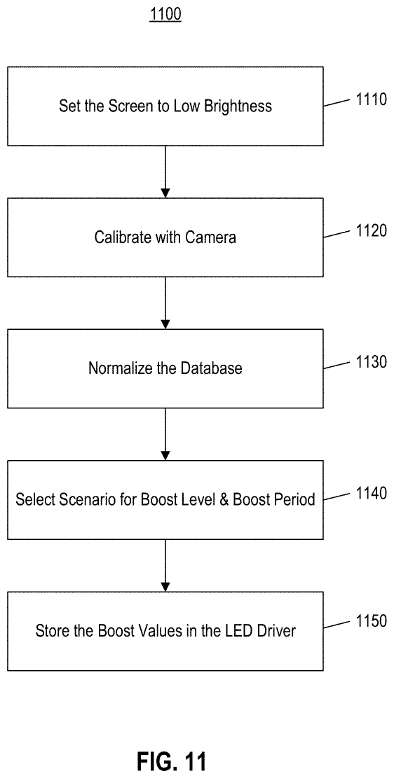

FIG. 11 is a flow diagram 1100 of an exemplary calibration process, according to some embodiments of the present disclosure. After setting the screen to a low brightness in step 1110, calibration with a camera is performed in step 1120. The database is then normalized in step 1130. Based on the normalized data, in step 1140, the scenarios for the boost levels and boost periods for each grey-scale vector can be selected. In step 1150, the boost values are stored in the 2D-DCM driver.

The calibration process may take place for every assembly of the display panel or for a new PCB design. In some embodiment, implementation of the process may involve ignoring the small variations in the LED capacitive contributions by the matrix.

With appropriate sensors, additional circuitry could adjust the boost levels and boost periods statically or dynamically after manufacture to compensate for changes in distortion or device wear over time.

The foregoing description is illustrative, not exhaustive, and the invention is not limited to forms or embodiments disclosed. For example, the description of the 2D-DCM techniques above assumed an implementation scenario of common-cathode configuration of LEDs, but the techniques also apply to a common-anode configuration of LEDs. Also, certain components have been described as coupled to one another, but such components may be integrated with one another or distributed in an alternative suitable fashion.

Other embodiments will be apparent from a consideration of the specification and practice of the disclosed embodiments. The following claims define the scope of the invention.

What is claimed is:

1. An LED driver to drive a matrix of LEDs in response to display signals comprising:
a two-dimensional pulse profile engine configured to:
receive the display signals and timing signals, and
produce, based on the received display signals and timing signals, a pulse profile defining signal amplitudes at various times during a driving pulse to produce a desired LED output that accounts for artifacts of the LED matrix and other driver circuitry;
current forming circuitry configured to form a driving pulse to reflect the pulse profile; and
driver circuitry configured to, based on the pulse profile and the driving pulse, form a current pulse to drive one or more of the LEDs, driving circuitry being coupled to the two-dimensional pulse profile engine and the current forming circuitry.

2. The LED driver of claim 1, wherein the two-dimensional pulse profile engine includes a memory storing predefined pulse profiles.

3. The LED driver of claim 1, wherein the two-dimensional pulse profile engine includes a dynamic decision engine configured to form pulse profile according to a pre-defined profile algorithm.

4. The LED driver of claim 1, wherein the two-dimensional pulse profile engine includes:
a base current generator configured to generate a current signal representing the lowest driving current for the one or more LEDs;
a boost current generator configured to generate currents to respond to one or more artifacts of the LED matrix; and
an adder, coupled to the base current generator and the boost current generator, configured to form the pulse profile.

5. The LED driver of claim 1, wherein the driver circuitry includes a switch to control when the driving pulse is active.

6. The LED driver of claim 1, wherein the two-dimensional pulse profile engine includes current switches coupled to current sources.

7. The LED driver of claim 1, wherein the current forming circuitry includes a digital counter that counts at a greyscale clock frequency to determine timing of boost segments.
